(19) United States
(12) Patent Application Publication
(10) Pub. No.: US 2016/0153629 A1
(43) Pub. Date: Jun. 2, 2016

(54) LUMINAIRE HAVING A CURVED PRISM STRUCTURE ELEMENT

(71) Applicant: ZUMTOBEL LIGHTING GMBH, Lemgo (DE)

(72) Inventor: Lennart SULZBACH, Hameln (DE)

(73) Assignee: Zumtobel Lighting GMBH, Lemgo (DE)

(21) Appl. No.: 14/905,795

(22) PCT Filed: Jul. 22, 2014
(86) PCT No.: PCT/EP2014/065706

§ 371 Date: Jan. 16, 2016

(30) Foreign Application Priority Data
Jul. 22, 2013 (DE) 20 2013 103 270.0

(51) Int. Cl. F21S 8/02; F21V 13/04; F21V 5/02

(52) U.S. Cl. CPC F21S 8/026; F21V 5/02; F21V 13/04; F21Y 2101/02

(57) ABSTRACT

A luminaire having a light source for producing light, a reflector for influencing the light and a refractive element for further influencing the light, the refractive element being curved and including a surface having a prism structure is disclosed.

The invention relates to a luminaire comprising a light source, a reflector and a light-refracting element.

DE 10 2011 079 404 A1 discloses such a luminaire. In this case, the lens is arranged optically between the light source and the reflector. However, the lens in this case forms very restrictive boundary conditions with regard to the design of the shape and size of the reflector.

The invention is based on the object of specifying a corresponding improved luminaire. In particular, the luminaire is intended to have improved possibilities with regard to the design of the optical properties in conjunction with an overall small structural embodiment.

This object is achieved according to the invention by means of the subject matter stated in the independent claim. Particular types of embodiment of the invention are specified in the dependent claims.

According to the invention, a luminaire is provided, comprising a light source for generating light, a reflector for influencing the light, and a light-refracting element for further influencing the light. In this case, the light-refracting element is shaped in a curved fashion and has a surface provided with a prism structure.

This embodiment of the light-refracting element results in an improvement particularly in the design possibilities for the luminaire with regard to the relative arrangement between the light-refracting element, on the one hand, and the reflector, on the other hand, and thus with regard to the optical properties of the luminaire. By way of example, what can be achieved in this way is that a large wall region can be illuminated by the luminaire obliquely and particularly uniformly in this case.

Preferably, the prism structure is a microprism structure. In this case, “microprism structure” can be understood to mean, in particular, a structure having a structure height of less than 1 mm.

Particularly suitable optical properties of the luminaire can be achieved if the luminaire is fashioned in such a way that the surface forms a light exit surface of the light-refracting element for the light generated by the light source. With further advantage, the surface is preferably shaped in a concavely curved fashion at least to a first approximation. This is intended to describe the overall shape of the surface or of the light exit surface, that is to say in particular the “principal shape” of the surface disregarding the prism structure.

Preferably, a light exit region of the luminaire is formed by an edge of the reflector, said light exit region having a diameter. In this case, a particularly advantageous shape of the surface or of the light exit surface can be achieved if the latter has at least to a first approximation a curvature described by a radius of curvature that is greater than half of the diameter of the light exit region and less than double the diameter of the light exit region.

Preferably, the light-refracting element furthermore has a further surface, wherein the further surface forms a light entrance surface of the light-refracting element for the light. In this case, in particular, a particularly small design of the luminaire can be achieved if the further surface is shaped in a convexly curved fashion at least to a first approximation.

Preferably, the light-refracting element substantially has the shape of a curved disk or of a lens, wherein it is shaped in such a way that between the surface and the further surface it has a thickness which varies by less than 100%, preferably by less than 50%, particularly preferably by less than 30%. In this way, the light-refracting element can be fashioned such that it is particularly “thin” and thus in a space-saving manner.

Advantageously in terms of production engineering, the light-refracting element is fashioned as an injection-molded part. In this way, in particular, the shape of the light-refracting element can be adapted particularly well to the shape of the reflector.

Preferably, the light-refracting element is arranged in a mariner directly adjoining a reflective inner wall region of the reflector. A particularly direct optical interaction between the light-refracting element, on the one hand, and the reflector, on the other hand, can be achieved as a result.

Preferably, the light source comprises at least one LED. This is particularly advantageous with regard to the structural size of the luminaire and the lifetime and the efficiency of the light source.

Preferably, a plane is defined by the edge of the reflector, wherein the light source has a circuit board arranged in a manner aligned in a further plane, wherein the further plane forms an angle with the first-mentioned plane, said angle being between 40° and 80°, preferably between 50° and 70°. In this way, the luminaire is particularly well suited to “oblique” emission of light. In particular, the luminaire is suitable if it is fashioned as a wall washer.

Particularly advantageously it can be fashioned as a recessed luminaire.

The invention is explained in greater detail below on the basis of an exemplary embodiment and with reference to the drawings, in which:

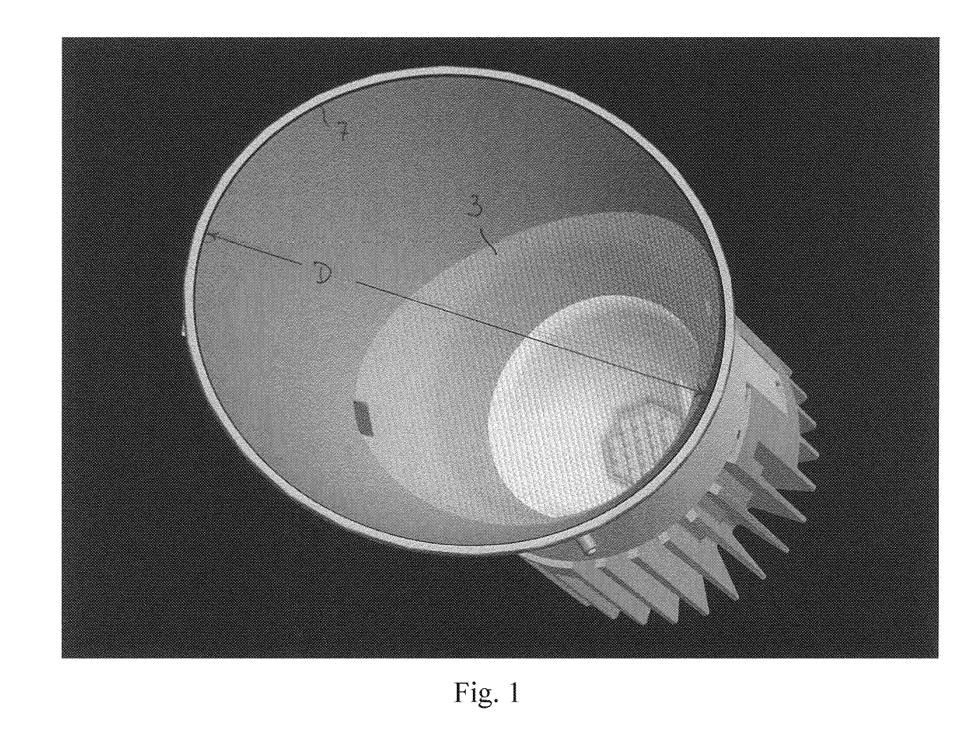

FIG. 1 shows a perspective schematic diagram of a luminaire according to the invention,

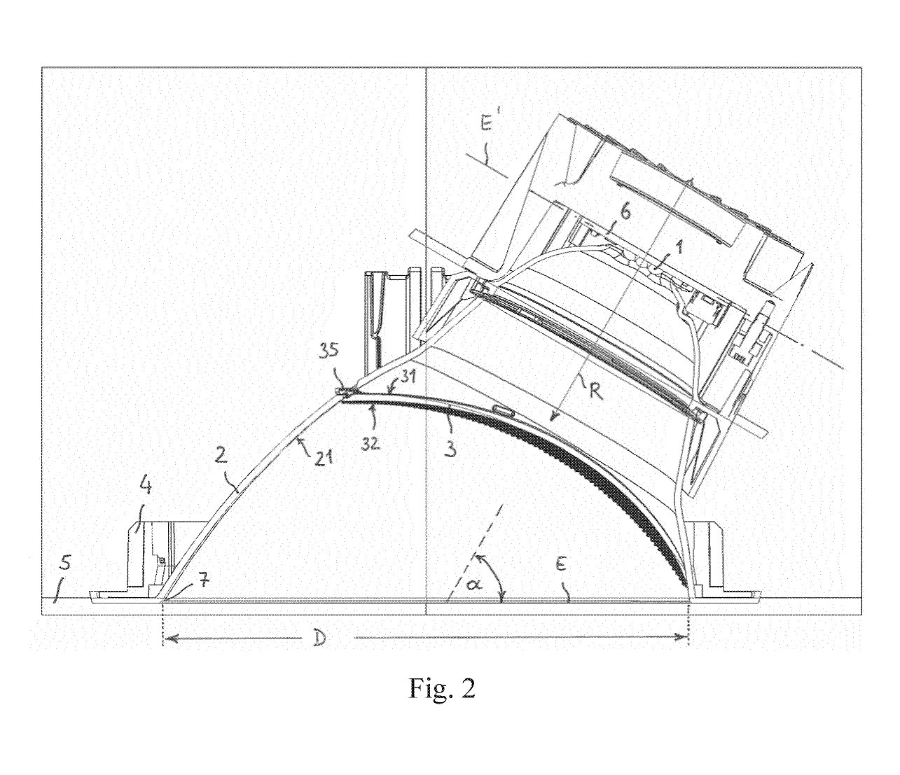

FIG. 2 shows a cross-sectional schematic diagram through the luminaire, and

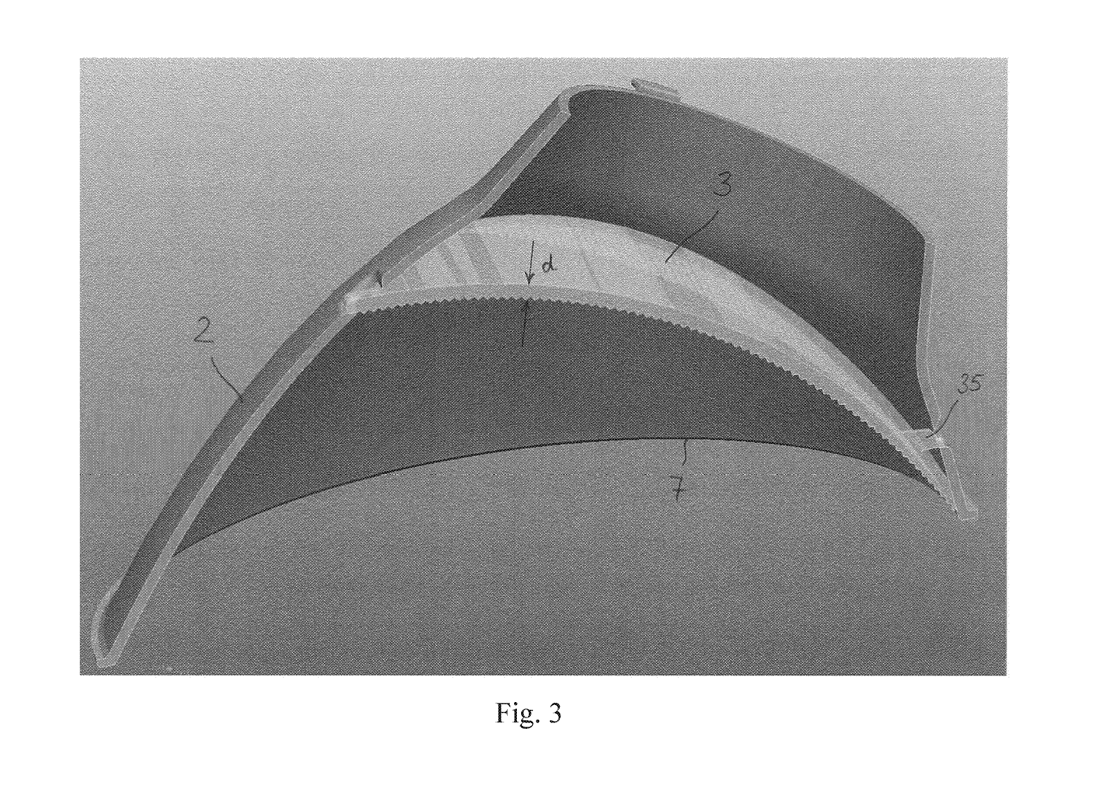

FIG. 3 shows a sectional, perspective schematic diagram containing the relative arrangement between the light-refracting element and the reflector.

FIG. 1 shows a perspective schematic diagram of a luminaire according to the invention. In the exemplary embodiment shown here, the luminaire is fashioned as a “wall washer”. Such a luminaire is provided for illuminating a wall region. It can be provided, for example, for being arranged for operation on or in a room ceiling and for illuminating obliquely from above a vertical wall section adjoining the room ceiling. The luminaire can therefore accordingly be fashioned as a surface-mounted luminaire or—as is the case in the example shown here—as a recessed luminaire.

FIG. 2 shows a cross-section through the luminaire. By way of example, the luminaire can be provided or fashioned for being held for operation by means of an installation ring 4 in an installation opening of a wall element 5, or of a ceiling element.

The luminaire comprises a light source 1 for generating light. In the example shown here, the light source 1 comprises at least one LED. In particular, the at least one LED can be provided in a manner arranged on a circuit board 6. Preferably, the circuit board 6 is of plate-shaped design and has a surface on which the at least one LED is arranged, wherein the surface has a surface normal that defines a principal emission direction R of the light source 1.

Furthermore, the luminaire comprises a reflector 2 for influencing the light, in particular for influencing the direction behavior of the light. Preferably, the reflector 2 has an edge 7 that forms a light exit region of the luminaire having a diameter D. The light exit region generally need not be circular. In the case of a non-circular light exit region, “diameter” shall denote the largest extent of the light exit region.

In the example shown, the edge 7 of the reflector 2 is fashioned in a manner running in a plane E. In this case, the plate-shaped circuit board 6 is arranged in a manner aligned in a further plane E′, wherein said further plane E′ forms an angle α with the first-mentioned plane E, said angle preferably being between 40° and 80°, for example between 50° and 70°. By way of example, the angle can be between 58° and 62°.

Furthermore, the luminaire comprises a light-refracting element 3 for further influencing the light. The light-refracting element 3 is shaped in a curved fashion and has a surface 32 provided with a prism structure. It is preferably provided that the prism structure extends across the entire surface 32.

The prism structure is preferably a microprism structure. The light-refracting element 3 is preferably fashioned such that it serves, in particular as a result of an effect of the prism structure, for suppressing glare of the light generated by the light source 1.

The surface 32 of the light-refracting element 3 preferably forms a light exit surface of the light-refracting element 3 for the light generated by the light source 1.

By means of the light-refracting element 3 in conjunction with the reflector 2, the light generated by the light source 1 can be directed onto a wall region to be illuminated at particularly shallow angles in particular in such a way that said wall region is illuminated particularly uniformly across its entire height.

FIG. 3 shows a sectional, perspective schematic diagram illustrating by way of example the relative arrangement between the reflector 2 and the light-refracting element 3. The surface 32 of the light-refracting element 3 or the light exit surface is preferably shaped in a concavely curved fashion at least to a first approximation. In this case, “to a first approximation” shall express the fact, in particular, that the shape of the surface 32 is described as considered in its entirety, that is to say at any rate disregarding the prism structure formed on the surface 32.

Preferably, the shape of the light-refracting element 3, in particular the shape of the surface 32 or of the light exit surface, is coordinated with the configuration of the reflector 2. For this purpose, provision can be made, in particular, for the surface 32 to have at least to a first approximation a curvature described by a radius of curvature that is greater than half of the diameter D of the light exit region and less than double the diameter of the light exit region.

In the example shown, the surface 32 has said curvature in a sectional plane oriented both normally to the plane E and normally to the further plane E′; said sectional plane thus corresponds to the plane of the drawing in FIG. 2. The surface 32 can furthermore be fashioned or shaped in such a way that, as viewed in a further section positioned normally to the plane E and normally to the aforementioned sectional plane, said surface is not curved or has a smaller curvature.

With further preference, the light-refracting element 3 additionally has a further surface 31, which forms a light entrance surface of the light-refracting element 3 for the light generated by the light source. In this case, said further surface 31 is preferably shaped in a convexly curved fashion at least to a first approximation. As a result, the light-refracting element 3 can be of particularly small-scale design.

In particular, the light-refracting element 3 can have the shape of a curved disk or of a lens having a substantially uniform thickness across its entire extent. In particular, the light-refracting element 3 can be shaped in such a way that between the surface 32 and the further surface 31—or between the light exit surface and the light entrance surface—it has a thickness d that varies by less than 100%, preferably by less than 50%, particularly preferably by less than 30%.

Preferably, the light-refracting element 3 is arranged in a manner directly adjoining a reflective inner wall region 21 of the reflector 2. In this way, an optical interaction of the light-refracting element 3 with the reflector 2 can be fashioned particularly directly and thus effectively. In the example shown, the design is such that the optical element 3 has an edge adjoining the inner wall region 21 of the reflector 2 on all sides, as is evident suggestively from FIG. 1

The light-refracting element 3 is preferably fashioned as an injection-molded part. In this way, the shape of the light-refracting element 3 can be adapted particularly well to the shape of the reflector 2, in particular to the shape of the reflective inner wall region 21. Production by injection molding is additionally more advantageous, in particular more cost-effective, than production by milling.

Preferably, the reflector 2 consists of a metal and the light-refracting element 3 consists of a plastic.

The light-refracting element 3 can have integrally formed holding elements 35, in particular integrally formed on the further surface 31, which engage into appropriately corresponding cutouts of the reflector 2 for the purpose of mounting the light-refracting element 3 on the reflector 2.

The light-refracting element 3 can be fashioned such that it has a magnification factor of between 5 and 20, for example approximately 10, with regard to the light generated by the light source 1.

1. A luminaire comprising:
a light source for generating light,
a reflector for influencing the light, and
a light-refracting element for further influencing the light,
wherein the light-refracting element is shaped in a curved fashion and has a surface provided with a prism structure.

2. The luminaire as claimed in claim 1, wherein the prism structure is a microprism structure.

3. The luminaire as claimed in claim 1, which is fashioned in such a way that the surface forms a light exit surface of the light-refracting element for the light.

4. The luminaire as claimed in claim 1, wherein the surface is shaped in a concavely curved fashion at least to a first approximation.

5. The luminaire as claimed in claim 1, wherein a light exit region of the luminaire is formed by an edge of the reflector said light exit region having a diameter (D).

6. The luminaire as claimed in claim 5, wherein the surface of the light-refracting element has at least to a first approximation a curvature described by a radius of curvature that is greater than half of the diameter (D) of the light exit region and less than double the diameter (D) of the light exit region.

7. The luminaire as claimed in claim 1, wherein the light-refracting element furthermore has a further surface, wherein the further surface forms a light entrance surface of the light-refracting element for the light.

8. The luminaire as claimed in claim 7, wherein the further surface is shaped in a convexly curved fashion at least to a first approximation.

9. The luminaire as claimed in claim 7, wherein the light-refracting element substantially has the shape of a curved disk or of a lens, wherein it is shaped in such a way that between the surface and the further surface it has a thickness (d) which varies by less than 100%, preferably by less than 50%, particularly preferably by less than 30%.

10. The luminaire as claimed in claim 1, wherein the light-refracting element (3) is fashioned as an injection-molded part.

11. The luminaire as claimed in claim 1, wherein the light-refracting element (3) is arranged in a manner directly adjoining a reflective inner wall region (21) of the reflector (2).

12. The luminaire as claimed in claim 1, wherein the light source (1) comprises at least one LED.

13. The luminaire as claimed in claim 5, wherein a plane (E) is defined by the edge (7) of the reflector and the light source has a circuit board arranged in a manner aligned in a further plane (E′), wherein the further plane (E′) forms an angle (α) with the first-mentioned plane (E), said angle being between 40° and 80°, preferably between 50° and 70°.

14. The luminaire as claimed in claim 1, in the form of a wall washer.

15. The luminaire as claimed in claim 1, in the form of a recessed luminaire.
